(19) United States
(12) Patent Application Publication
(10) Pub. No.: US 2024/0141187 A1
(43) Pub. Date: May 2, 2024

(54) INKJET INK AND INKJET RECORDING APPARATUS

(71) Applicant: KYOCERA Document Solutions Inc., Osaka (JP)

(72) Inventor: Shunta EHARA, Osaka (JP)

(73) Assignee: KYOCERA Document Solutions Inc., Osaka (JP)

(21) Appl. No.: 18/490,575

(22) Filed: Oct. 19, 2023

(30) Foreign Application Priority Data
Oct. 28, 2022 (JP) 2022-173784

(51) Int. Cl. C09D 11/03; C09D 11/322

(52) U.S. Cl. CPC C09D 11/03; C09D 11/322

(57) ABSTRACT

Inkjet ink contains a pigment, a water-soluble organic solvent, water, and a surfactant. The water-soluble organic solvent contains both a glycol ether and a glycol compound. The inkjet ink has an Ohnesorge number Oh of 0.180 or more but 0.188 or less.

### INCORPORATION BY REFERENCE

This application is based on and claims the benefit of priority from Japanese Patent Application No. 2022-173784 filed on Oct. 28, 2022, the contents of which are hereby incorporated by reference.

### BACKGROUND

The present disclosure relates to inkjet ink, and to inkjet recording apparatuses.

An inkjet recording apparatus ejects, from a recording head provided in it, inkjet ink to form an image on a recording medium. Increasing the ejection speed of inkjet ink may cause what is called the satellite phenomenon, that is, displacement of the ink landing position along the conveyance direction of the recording medium.

### SUMMARY

According to one aspect of the present disclosure, inkjet ink contains a pigment, a water-soluble organic solvent, water, and a surfactant. The water-soluble organic solvent contains both a glycol ether and a glycol compound. The inkjet ink has an Ohnesorge number Oh of 0.180 or more but 0.188 or less as expressed by Formula (1) below

$$Oh = \frac{μ}{\sqrt{ρσ L}} \qquad ( 1 )$$

In Formula (1) above, μ represents the viscosity of the inkjet ink, ρ represents the density of the inkjet ink, σ represents the dynamic surface tension of the inkjet ink with a surface age of 0.027 milliseconds, and L represents the ink droplet diameter of the inkjet ink.

This and other objects of the present disclosure, and the specific benefits obtained according to the present disclosure, will become apparent from the description of embodiments which follows.

### BRIEF DESCRIPTION OF THE DRAWINGS

FIG. 1 is a graph showing one example of the relationship between dynamic surface tension and surface age in the measurement of the dynamic surface tension of reference ink by the maximum bubble pressure method.

FIG. 2 is a diagram showing one example of an inkjet recording apparatus according to a second embodiment of the present disclosure.

### DETAILED DESCRIPTION

An embodiment of the present disclosure will be described below.

First, known related technologies will be discussed. To suppress the satellite phenomenon, known liquid ejection devices include a nozzle, an actuator for producing the energy to eject liquid through the nozzle, and a controller. The actuator is driven such that the Ohnesorge number falls within a predetermined range.

Inconveniently, known liquid ejection devices leave room for improvement in terms of suppression of displaced ejection from the recording head.

On the other hand, inkjet recording apparatuses use, for example, aqueous inkjet ink. Inkjet ink is typically used for image formation on an osmotic recording medium such as regular paper, and is occasionally used also for image formation on poorly absorbent recording media such as coated paper, offset coated paper, and matt coated paper. A poorly absorbent recording medium absorbs an aqueous medium poorly. It is thus known that forming a line image on a poorly absorbent recording medium with aqueous inkjet ink containing an aqueous medium tends to result in blurring, with an increased line width.

In view of what has been discussed above, an object of the present disclosure is to provide inkjet ink, and an inkjet recording apparatus, that can suppress displaced ejection from a recording head and that can produce an image with the desired line width on a poorly absorbent recording medium.

Next, some of the terms used herein will be defined. The static surface tension of a measurement target will be given as a value determined at 25° C. by the Wilhelmy method (plate method) on a surface tension tester (e.g., Automatic Surface Tensiometer DY-300 manufactured by Kyowa Interface Science Co., Ltd.). The cumulative 50% value (D₅₀) of the particle size distribution by mass of a measurement target will be given as, unless otherwise stated, a median diameter determined on a laser diffraction/scattering particle size distribution tester (“LA-950” manufactured by HORIBA, Ltd.). “Acrylic” and “methacrylic” are occasionally referred to collectively as “(meth)acrylic.” In the present disclosure, any ingredient may be a single substance or a combination of two or more substances.

### First Embodiment: Inkjet Ink

According to a first embodiment of the present disclosure, inkjet ink (hereinafter occasionally referred to simply as “ink”) contains a pigment, a water-soluble organic solvent, water, and a surfactant. The water-soluble organic solvent contains both a glycol ether and a glycol compound. The ink of the first embodiment has an Ohnesorge number Oh of 0.180 or more but 0.188 or less as expressed by Formula (1) below.

$$Oh = \frac{μ}{\sqrt{ρσ L}} \qquad ( 1 )$$

In Formula (1), μ represents the viscosity of the ink, ρ represents the density of the ink, σ represents the dynamic surface tension of the ink with a surface age of 0.027 milliseconds, and L represents the ink droplet diameter. In the following description, “dynamic surface tension with a surface age of 0.027 milliseconds” will be referred to simply as “dynamic surface tension σ.”

The ink of the first embodiment can be suitably used for image formation on a poorly absorbent recording medium, which absorbs an aqueous medium poorly compared with an osmotic recording medium (e.g., regular paper). Examples of poorly absorbent recording media include surface-treated paper (e.g., coated paper, offset coated paper, and matt coated paper), resin recording media, metal recording media, glass recording media, and ceramic recording media.

Configured as described above, the ink of the first embodiment can suppress displaced ejection from the recording head and can form an image with the desired line width on a poorly absorbent recording medium. The reason is considered to be as follows. Known ink containing an aqueous medium is poorly absorbed by a poorly absorbent recording medium and tends to excessively spread while wet. Here, the ink of the first embodiment has an Ohnesorge number of 0.180 or more but 0.188 or less. With an Ohnesorge number of 0.180 or more, ink does not excessively spread while wet on a poorly absorbent recording medium and can form an image with a comparatively fine line. On the other hand, with an Ohnesorge number of 0.188 or less, ink has a suitably adjusted balance of viscosity and dynamic surface tension σ and this helps suppress displaced ejection from the recording head.

Moreover, the ink of the first embodiment contains as a water-soluble organic solvent both a glycol ether and a glycol compound. Glycol ethers are highly hydrophobic. Thus, adding a glycol ether to ink enhances the ink's affinity with a poorly absorbent recording medium. Ink containing a glycol compound dries easily on a poorly absorbent recording medium. As a result, the ink of the first embodiment can form an image properly on a poorly absorbent recording medium. For example, even when, with no treatment liquid ejected onto the poorly absorbent recording medium, the ink of the first embodiment is ejected directly onto the poorly absorbent recording medium, the ink of the first embodiment can form an image properly on the poorly absorbent recording medium.

<Ohnesorge Number Oh>

As already mentioned, the ink of the first embodiment has an Ohnesorge number Oh of 0.180 or more but 0.188 or less. The Ohnesorge number Oh is calculated according to Formula (1) noted above from the viscosity μ, the dynamic surface tension σ, etc. of the ink. Thus, by adjusting the Ohnesorge number Oh of the ink within a predetermined range, it is possible to adjust the balance between the viscosity μ and the dynamic surface tension σ of the ink. To form an image with the desired line width, and to suppress displaced ejection of ink from the recording head, it is effective, rather than to adjust only one of the viscosity μ and the dynamic surface tension σ of the ink, to find an adequate balance between the viscosity and the dynamic surface tension σ of the ink. Accordingly, to form an image with the desired line width, and to suppress displaced ejection of ink from the recording head, it is effective to adjust the Ohnesorge number Oh of the ink within a predetermined range.

There is a tendency that, the higher the viscosity μ of the ink, the greater the numerator of Formula (1) and the higher the Ohnesorge number Oh of the ink. On the other hand, there is a tendency that, the higher the dynamic surface tension σ of the ink, the greater the denominator of Formula (1) and the lower the Ohnesorge number Oh of the ink.

To form an image with the desired line width, and to suppress displaced ejection of ink from the recording head, the dynamic surface tension σ of the ink is preferably 53.0 mN/m or more but 58.0 mN/m or less. With the dynamic surface tension σ of the ink within the range mentioned above, the ink has enhanced moisture retention.

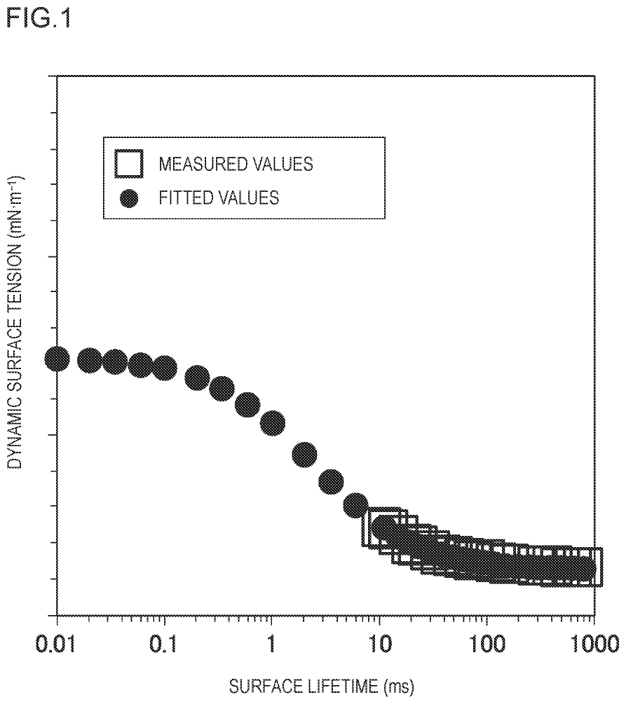

The dynamic surface tension σ of the ink is a value determined in an environment at a temperature of 25° C. The dynamic surface tension σ of the ink (i.e., its dynamic surface tension with a surface age of 0.027 milliseconds) can be measured, for example, by the maximum bubble pressure method. Now, with reference to FIG. 1, a method of measuring the dynamic surface tension σ will be described. FIG. 1 is a graph showing one example of the relationship between dynamic surface tension (γ) and surface age (t) in the measurement of the dynamic surface tension of reference ink by the maximum bubble pressure method. Note that the graph of FIG. 1, which shows measurements with reference ink that differs from ink according to the present disclosure, is used here only for the purpose of describing the measurement method.

In the measurement of the dynamic surface tension (γ) of ink by the maximum bubble pressure method, an extremely short surface age (t) (e.g., a surface age less than 10 milliseconds) makes the measurement of the dynamic surface tension (γ) difficult. So, for the dynamic surface tension (γ) of ink with an extremely short surface age t, it is not actually measured but is determined in the following way. First, the dynamic surface tension (γ) of ink with a measurement-compatible surface age t (e.g., 10 milliseconds or more but 1000 milliseconds or less) is measured. Next, the actually measured value is subjected to Hua-Rosen fitting such that Formula (2) below holds to calculate the dynamic surface tension (γ) with an extremely short surface age t (e.g., 0.010 milliseconds or more but less than 10 milliseconds). In this way, the dynamic surface tension (γ) of ink with an extremely short surface age can be determined. From the dynamic surface tension (γ) of ink determined by Hua-Rosen fitting, the dynamic surface tension σ of ink (i.e., its dynamic surface tension with a surface age of 0.027 milliseconds) can be determined.

γ(t)=γ_{eq}+(γ₀−γ_{eq})/{1+(t/τ)^{k}} (2)

In Formula (2), t represents the surface age (in milliseconds). The symbol γ(t) represents the dynamic surface tension (in mN/m) with a surface age t (in milliseconds). The symbol γ₀ represents the dynamic surface tension (in mN/m) of ink with a surface age of 0 milliseconds. The dynamic surface tension (γ₀) of ink with a surface age of 0 milliseconds is regarded as approximately equal to the dynamic surface tension (γ_{0.010}) of ink with a surface age of 0.010 milliseconds immediately after interface formation. The dynamic surface tension (γ₀) corresponds to the static surface tension of a sample composition prepared by replacing the surfactant in ink with the same amount of water. The symbol γ_{eq} represents the dynamic surface tension (in mN/m) of ink with a surface age of 1000 milliseconds. The dynamic surface tension (γ_{eq}) of ink with a surface age of 1000 milliseconds is the dynamic surface tension (γ) of ink with its dynamic surface tension (γ) in equilibrium. The dynamic surface tension (γ_{eq}) corresponds to the static surface tension of ink. The symbol τ represents the relaxation time (in milliseconds). The relaxation time τ is the surface age t with which the dynamic surface tension takes the middle value between the dynamic surface tension (γ₀) and the dynamic surface tension (γ_{eq}), that is, (γ₀+γ_{eq})/2. A smaller value of the relaxation time τ indicates a faster fall of the dynamic surface tension (γ) of ink. In Formula (2), k is a constant (relaxation coefficient).

To form an image with the desired line width, and to suppress displaced ejection of ink from the recording head, the viscosity μ of the ink is preferably 5.60 mPa·s or more but 5.80 mPa·s or less, and more preferably 5.60 mPa·s or more but 5.65 mPa·s or less or 5.70 mPa·s or more but 5.80 mPa·s or less, The viscosity μ of the ink is a value determined in an environment at a temperature of 32° C. The viscosity μ of the ink can be measured by, for example, a method that will be described later in connection with practical examples.

To form an image with the desired line width, and to suppress displaced ejection of ink from the recording head, the density ρ of the ink is preferably 0.50 g/cm³ or more but 2.00 g/cm³ or less. The density ρ of the ink is a value measured in an environment at a temperature of 32° C. The density ρ of the ink can be measured by, for example, a method that will be described later in connection with practical examples.

To form an image with the desired line width, and to suppress displaced ejection of ink from the recording head, the droplet diameter L of the ink is preferably 16.15 μm or more but 16.50 μm or less, and more preferably 16.1 5 μm or more but 16.20 μm or less or 16.25 μm or more but 16.50 μm or less. The droplet diameter L of the ink is, for example, the diameter of ink droplets before landing on the recording medium after being ejected from the recording head. The droplet diameter L of the ink is a value measured in an environment at a temperature of 32° C. The droplet diameter L of the ink can be measured by, for example, a method that will be described later in connection with practical examples.

<Pigment>

The pigment forms, for example along with a pigment coating resin, pigment particles. A pigment particle is composed of, for example, a core containing the pigment and a coating layer that coats the core. The coating layer is formed of the pigment coating resin. The pigment coating resin is present, for example, in a form dispersed in the solvent. For enhanced color density, hue, and stability of the ink, the D₅₀ value of pigment particles is preferably 30 nm or more but 200 nm or less, and more preferably 70 nm or more but 130 nm or less.

The pigment can be, for example, a yellow, orange, red, blue, violet, or black pigment. Examples of yellow pigments include C.I. Pigment Yellows (74, 93, 95, 109, 110, 120, 128, 138, 139, 151, 154, 155, 173, 180, 185, and 193). Examples of orange pigments include C.I. Pigment Oranges (34, 36, 43, 61, 63, and 71). Examples of red pigments include C.I. Pigment Reds (122 and 202). Examples of blue pigments include C.I. Pigment Blues (15, more specifically 15:3). Examples of violet pigments include C.I. Pigment Violets (19, 23, and 33). Examples of black pigments include C.I. Pigment Black (7).

The content of the pigment in the ink is preferably 0.5% by mass or more but 10.0% by mass or less, and more preferably 1.5% by mass or more but 5.0% by mass or less. A content of the pigment of 0.5% by mass or more makes it easy to form an image with the desired image density with the ink. A content of the pigment of 10.0% by mass or less gives the pigment increased fluidity in the ink. This makes it easy to form an image with the desired image density with the ink.

<Pigment Coating Resin>

The pigment coating resin is, for example, a resin soluble in the ink, or a resin that can be dispersed in the ink. Part of the pigment coating resin is present, for example, at the surface of pigment particles and serves to enhance the dispersion of pigment particles. Part of the pigment coating resin is present, for example, in a state dissolved or dispersed in the ink. Preferred as the pigment coating resin is an acrylic resin. An acrylic resin is a polymer of at least one monomer out of (meth)acrylic acid and alkyl esters of (meth)acrylic acid.

The content of the pigment coating resin in the ink is preferably 0.1% by mass or more but 5.0% by mass or less, and more preferably 0.5% by mass or more but 2.0% by mass or less.

<Water-Soluble Organic Solvent>

The water-soluble organic solvent functions, along with water, a solvent or a dispersion medium in the ink. The water-soluble organic solvent contains both a glycol ether and a glycol compound.

(Glycol Ether)

A glycol ether enhances the affinity of the ink with a poorly absorbent recording medium and gives the ink an adequate dynamic surface tension.

A glycol ether is a compound in which the hydroxyl group (—OH group) at one end or both ends of an alkylene glycol compound is replaced with a lower alkyl group. The glycol ether can be, for example, an alkylene glycol alkyl ether, and more specifically a monoalkyl ether of a mono-, di-, or trialkylene glycol. Examples of the glycol ether include ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, dipropylene glycol monomethyl ether, dipropylene glycol monoethyl ether, triethylene glycol monomethyl ether, triethylene glycol monobutyl ether, triprolylene glycol monomethyl ether.

It is preferable that the glycol ether contain triethylene glycol monobutyl ether. The content of triethylene glycol monobutyl ether in the glycol ether is preferably 80% by mass or more, more preferably 90% by mass or more, and particularly preferably 100% by mass.

The ratio WB/WA of the mass WB of the glycol ether to the mass MA of the glycol compound is preferably 0.20 or more but 0.55 or less, and more preferably 0.20 or more but 0.50 or less.

The content of the glycol ether in the ink is preferably 3.0% by mass or more but 25.0% by mass or less, more preferably 6.0% by mass or more but 18.0% by mass or less, and further preferably 8.0% by mass or more but 16.0% by mass or less.

(Glycol Compound)

Adding a glycol compound to the ink makes it easy to dry on a poorly absorbent recording medium.

Examples of the glycol compound include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, and tetraethylene glycol.

It is preferable that the glycol compound contain propylene glycol. The content of propylene glycol in the glycol compound is preferably 80% by mass or more, more preferably 90% by mass or more, and particularly preferably 100% by mass.

The content of the glycol compound in the ink is preferably 15.0% by mass or more but 55.0% by mass or less, more preferably 20.0% by mass or more but 50.0% by mass or less, still more preferably 31.0% by mass or more but 40.0% by mass or less, and further preferably 31.5% by mass or more but 40.0% by mass or less. The content of the glycol compound in the ink may be 20.0% by mass or more but less than 35.0% by mass.

(Other Water-Soluble Organic Solvents)

The water-soluble organic solvent may contain, in addition to a glycol ether and a glycol compound, any other water-soluble organic solvent. Examples of such other water-soluble organic solvents include a lactam compound, a nitrogen-containing compound, an acetate compound, thiodiglycol, glycerol, and dimethyl sulfoxide.

Examples of lactam compounds include 2-pyrrolidon and N-methyl-2-pyrrolidone.

Examples of nitrogen-containing compounds include 1,3-dimethyl imidazolidinone, formamide, and dimethyl formamide.

Examples of acetate compounds include diethylene glycol monoethyl ether acetate.

Preferred as an additional water-soluble organic solvent is a lactam compound, and more preferably 2-pyrrolidon.

The content of the additional water-soluble organic solvent in the ink is preferably 15.0% by mass or more but 60.0% by mass or less, and more preferably 35.0% by mass or more but 45.0% by mass or less. The content of a lactam compound in the ink is preferably 0.3% by mass or more but 5.0% by mass or less, and more preferably 1.0% by mass or more but 2.0% by mass or less.

<Water>

The content of water in the ink is preferably 20.0% by mass or more but 60.0% by mass or less, and more preferably 30.0% by mass or more but 50.0% by mass or less.

<Surfactant>

A surfactant enhances the wetting properties of the ink with the recording medium and the compatibility among the different ingredients of the ink.

Preferred as the surfactant is a non-ionic surfactant. Examples of non-ionic surfactants include silicone surfactants, acetylene surfactants (more specifically, acetylene glycol, ethylene oxide adducts of acetylene glycol, acetylenediol, and ethylene oxide adducts of acetylenediol). Examples of acetylenediol includes 2,4,7,9-tetramethyl-5-decyne-4,7-diol, 3,6-dimethyl-4-octyne-3,6-diol, 3,5-dimethyl-1-hexyn-3-ol, and 2,4-dimethyl-5-hexyn-3-ol. In the present disclosure, silicone surfactants are supposed to be those that have a siloxane bond in their molecules. In the present disclosure, acetylene surfactants are supposed to be those that have a triple bond between carbon atoms in their molecules.

To give the ink an adequate dynamic surface tension σ, and to adjust the Ohnesorge number Oh of the ink within a predetermined range, the surfactant is preferably a non-ionic surfactant, more preferably an acetylene surfactant, and further preferably an ethylene oxide adduct of acetylene glycol or an ethylene oxide adduct of acetylenediol.

To adjust the Ohnesorge number Oh of the ink within a predetermined range, it is preferable that the surfactant have an HLB value of 3 or more but 15 or less, and more preferably 3 or more but 5 or less, 7 or more but 9 or less, or 12 or more but 15 or less.

To adjust the Ohnesorge number Oh of the ink within a predetermined range, it is preferable that the surfactant be an acetylene surfactant and that the content of the acetylene surfactant in the ink be 0.3% by mass or more but 0.9% by mass or less. In this case, it is more preferable that the content of the acetylene surfactant in the ink be 0.5% by mass or more but 0.7% by mass or less.

To adjust the Ohnesorge number Oh of the ink within a predetermined range, it is preferable that the surfactant be an ethylene oxide adduct of acetylene glycol and that the content of the surfactant (more specifically, the ethylene oxide adduct of acetylene glycol) in the ink be 0.3% by mass or more but 0.8% by mass or less. In this case, it is more preferable that the content of the ethylene oxide adduct of acetylene glycol in the ink be 0.4% by mass or more but 0.6% by mass or less. In this case, it is preferable that the ethylene oxide adduct of acetylene glycol have an HLB value of 3 or more but 9 or less, and more preferably 3 or more but 5 or less or 7 or more but 9 or less.

To adjust the Ohnesorge number Oh of the ink within a predetermined range, it is preferable that the surfactant be an ethylene oxide adduct of acetylenediol and that the content of the surfactant (more specifically, the ethylene oxide adduct of acetylenediol) in the ink be 0.5% by mass or more but 1.5% by mass or less. In this case, it is more preferable that the content of the ethylene oxide adduct of acetylenediol in the ink be 0.9% by mass or more but 1.1% by mass or less. In this case, it is preferable that the ethylene oxide adduct of acetylenediol have an HLB value of 12 or more but 15 or less.

The content of the surfactant in the ink is preferably 0.1% by mass or more but 3.0% by mass or less, and more preferably 0.3% by mass or more but 1.5% by mass or less.

<Other Ingredients>

As necessary, any other known additives (specifically, agents for drying prevention, oxidation prevention, viscosity adjustment, pH adjustment, mold prevention, and moisture retention) may be added to the ink.

According to the first embodiment, it is preferable that ink have one of Compositions 1 to 4 shown in Table 1 below. In Table 1, the content of each ingredient is given as a range of values. For example, for the content of the pigment in Composition 1, the range “3.0-5.0” denotes that the content of the pigment in the ink is preferably 3.0% by mass or more but 5.0% by mass or less. The same applies to the content of any other ingredient.

TABLE 1

| Composition | | 1 | 2 | 3 | 4 |
|---|---|---|---|---|---|
| % by Mass | Pigment | 3.0-5.0 | 3.0-5.0 | 3.0-5.0 | 3.0-5.0 |
| | Pigment | 0.7-1.4 | 0.7-1.4 | 0.7-1.4 | 0.7-1.4 |
| | Coating Resin | | | | |
| | Ethylene | 14.0-18.0 | 14.0-18.0 | 14.0-18.0 | 6.0-10.0 |
| | Glycol | | | | |
| | Monobutyl | | | | |
| | Ether | | | | |
| | Propylene | 29.0-33.0 | 29.0-33.0 | 29.0-33.0 | 38.0-42.0 |
| | Glycol | | | | |
| | 2-Pyrrolidon | 1.0-2.0 | 1.0-2.0 | 1.0-2.0 | 1.0-2.0 |
| | Surfactant | 0.3-0.8 | 0.5-1.5 | 0.5-1.5 | 0.3-0.8 |

| | |
|---|---|
| Water | Rest |

<Method of Manufacturing Ink>

There is no particular restriction on the method of manufacturing the ink of the first embodiment so long as the pigment and the other ingredients that are blended as necessary can be mixed evenly. One example of the method of manufacturing the ink of the first embodiment involves stirring and evenly mixing the ingredients of the ink on a stirrer and then removing, with a filter (e.g., one with a pore size of 5 μm or less), foreign matter and coarse particles. If the method of manufacturing the ink involves adding water to it, it is preferable to use ion-exchange water.

### Second Embodiment: Inkjet Recording Apparatus

A second embodiment of the present disclosure deals with an inkjet recording apparatus. The inkjet recording apparatus according to the second embodiment includes a recording head that ejects ink onto a recording medium. The recording medium is a poorly absorbent recording medium. The ink ejected is the ink of the first embodiment. Accordingly, with the inkjet recording apparatus of the second embodiment, for the same reason as mentioned in connection with the first embodiment, it is possible to suppress displaced ejection from the recording head and to form an image with the desired line width on the poorly absorbent recording medium.

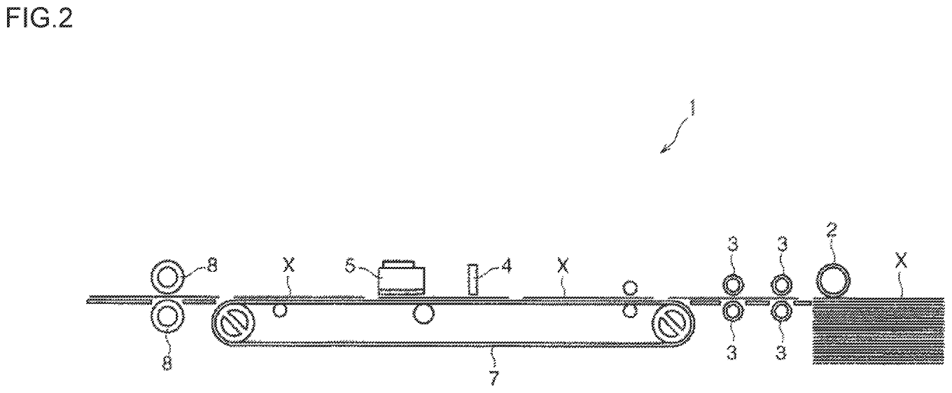

Now, with reference to FIG. 2, as one example of the inkjet recording apparatus of the second embodiment, an inkjet recording apparatus 1 will be described. FIG. 2 is a diagram showing one example of the inkjet recording apparatus of the second embodiment. The inkjet recording apparatus 1 shown in FIG. 2 is an inkjet printer that forms an image on a recording medium X with ink based on image information transmitted from an external device.

The inkjet recording apparatus 1 includes a sheet feed roller 2, a plurality of pairs of conveyance rollers 3, a sensor 4, a recording head 5, a conveyance belt 7, and discharge rollers 8.

The inkjet recording apparatus 1 includes a sheet storage (unillustrated). The sheet storage stores a plurality of sheets of a recording medium X stacked together. The sheet storage is, for example, a sheet feed cassette. The recording medium X is, for example, a poorly absorbent recording medium.

As the sheet feed roller 2 rotates, the recording medium X is fed out one sheet after another, starting with the topmost one. The recording medium X so fed out is delivered to the conveyance belt 7 by the plurality of pairs of conveyance rollers 3.

The conveyance belt 7 is an endless conveyance belt that is horizontally stretched between a pair of rollers. The recording medium X delivered by the plurality of pairs of conveyance rollers 3 is conveyed by the conveyance belt 7 as this rotates.

The sensor 4 is provided above the conveyance belt 7, upstream of the recording head 5 along the conveyance direction of the recording medium X. The sensor 4 senses the leading edge of the recording medium X conveyed by the conveyance belt 7. With reference to the time that the sensor 4 senses the leading edge of the recording medium X, the recording head 5 is fed with an instruction to eject ink.

The recording head 5 is provided above the conveyance belt 7, downstream of the sensor 4 along the conveyance direction of the recording medium X. The recording head 5 is disposed with no contact between its bottom face (nozzle face) and the recording medium X on the conveyance belt 7, and is fixed there. The recording head 5 stores the ink of the first embodiment. The recording head 5 ejects the ink onto the recording medium X.

The recording head 5 is, for example, a line head. More specifically, the recording head 5 is an elongate line head with a width equal to or larger than that of the recording medium X. The recording head 5 extends in the direction orthogonal to the conveyance direction of the recording medium X, and is fixed to the inkjet recording apparatus 1. The recording head 5 has a large number of nozzles in its nozzle face facing the conveyance belt 7 or the recording medium X. It can, by ejecting ink simultaneously over the entire width of the recording medium X, form an image on the recording medium X speedily. The recording head 5 can be, for example, a piezoelectric head or a thermal inkjet head.

The recording medium X having, while being conveyed on the conveyance belt 7, the image formed on it with the ink deposited by the recording head 5 is further conveyed by the conveyance belt 7. The recording medium X is then, at an end of the conveyance belt 7, delivered to the pair of discharge rollers 8 disposed one above the other, to be discharged off the conveyance belt 7.

While the inkjet recording apparatus 1 has been described as one example of the inkjet recording apparatus of the second embodiment with reference to FIG. 2, the inkjet recording apparatus of the second embodiment is not limited to one like the inkjet recording apparatus 1 described above. For example, an inkjet recording apparatus may include a plurality of recording heads. For example, a plurality of recording heads that eject Y (yellow) ink, M (magenta) ink, C (cyan) ink, and K (black) ink respectively may be disposed in a row along the conveyance direction of the recording medium X. Or, an inkjet recording apparatus may include a serial recording head, that is, one that scans the recording medium X.

The present disclosure also deals with an inkjet recording method. The inkjet recording method involves a step of ejecting ink from a recording head onto a recording medium. The recording medium is a poorly absorbent recording medium. The ink ejected is the ink of the first embodiment. Accordingly, with this inkjet recording method, for the same reason as mentioned in connection with the first embodiment, it is possible to suppress displaced ejection from the recording head and to form an image with the desired line width on the poorly absorbent recording medium. This inkjet recording method is implemented, for example, on the inkjet recording apparatus of the second embodiment.

### PRACTICAL EXAMPLES

Practical examples (P.Ex. 1 to 4) of the present disclosure will be described below, in comparison with comparative examples (C.Ex 1 to 2). Note that the practical examples described below are not meant to limit the scope of the present disclosure.

[Preparation of Pigment-Dispersed Liquid]

15 parts by mass of a cyan pigment (“HELIOGEN® BLUE D 7088” manufactured by BASF SE, C.I. Pigment Blue 15:3), 10 parts by mass of a dispersion liquid containing a pigment coating resin (“DISPERBYK® 190” manufactured by BYK-Chemie, non-volatile content: 40%, effective ingredient: acrylic resin), and 75 parts by mass of water were mixed and were subjected to preliminary dispersion on a disperser to obtain a mixture liquid. Next, the mixture liquid was subjected to dispersion on a beads mill. In this way, pigment-dispersed liquid C (pigment density: 15% by mass) was prepared.

[Preparation of Ink]

Ingredients were put in a container such that their contents in ink would be as shown in Table 2 below. The contents of the container were stirred to be mixed evenly at a rotation rate of 400 rpm on a stirrer (“Three-one Motor BL-600” manufactured by Shinto Scientific Co., Ltd.). To remove foreign matter and coarse particles, the resulting mixture liquid was filtered through a filter with a pore diameter of 5 μm. In this way, inks (CI-1) to (CI-6) were prepared.

Here are the details of the ingredients appearing in Table 2 below.

BT: triethylene glycol monobutyl ether (manufactured by NIPPON NYUKAZAI CO., LTD.

PG: propylene glycol (manufactured by DuPont Specialty Products Kabushiki Kaisha).

2-pyrrolidon: manufactured by Mitsubishi Chemical Corporation.

Surfactant (S440): non-ionic surfactant (“Surfynol® 440” manufactured by Nissin Chemical Co., Ltd.), an ethylene oxide adduct of acetylene glycol, effective ingredient density: 100% by mass, HLB value: 8).

Surfactant (S420): non-ionic surfactant (“Surfynol® 420” manufactured by Nissin Chemical Co., Ltd.), an ethylene oxide adduct of acetylene glycol, effective ingredient density: 100% by mass, HLB value: 4).

Surfactant (EXP): non-ionic surfactant (“Olfin® EXP4300” manufactured by Nissin Chemical Co., Ltd.), an acetylene surfactant, effective ingredient density: 60% by mass, solvent: propylene glycol and dipropylene glycol).

Surfactant (E1010): non-ionic surfactant (“Olfin® E1010” manufactured by Nissin Chemical Co., Ltd.), an ethylene oxide adduct of acetylenediol, effective ingredient density: 100% by mass, HLB value: 13.5±0.5).

In Table 2 below, “BT/PG” represents the ratio of the mass of triethylene glycol monobutyl ether to the mass of propylene glycol. This corresponds to the ratio of the mass of the glycol ether to the mass of the glycol compound.

TABLE 2

| | | | C. | P. | C. | P. | P. | P. |
|---|---|---|---|---|---|---|---|---|
| | | | Ex. 1 | Ex. 1 | Ex. 2 | Ex. 2 | Ex. 3 | Ex. 4 |
| Ink | | | CI-1 | CI-2 | CI-3 | CI-4 | CI-5 | CI-6 |
| % by | Pigment-Dispersed | | 26.7 | 26.7 | 26.7 | 26.7 | 26.7 | 26.7 |
| Mass | Liquid C | | | | | | | |
| | BT | | 16.0 | 16.0 | 16.0 | 16.0 | 16.0 | 8.0 |
| | PG | | 31.2 | 31.7 | 31.2 | 31.2 | 31.2 | 39.7 |
| | 2-Pyrrolidon | | 1.5 | 1.5 | 1.5 | 1.5 | 1.5 | 1.5 |
| | Surfactant | S440 | 1.0 | 0.5 | — | — | — | 0.5 |
| | | S420 | — | — | 1.0 | — | — | — |
| | | EXP | — | — | — | 1.0 | — | — |
| | | E1010 | — | — | — | — | 1.0 | — |

| | |
|---|---|
| Ion Exchange Water | Rest |
| Total | 100.0 |

| | | | | | | |
|---|---|---|---|---|---|---|
| BT/PG | 0.51 | 0.50 | 0.51 | 0.51 | 0.51 | 0.20 |

[Measurement]

For each ink, its dynamic surface tension σ, viscosity μ, density ρ, droplet diameter L, and Ohnesorge number Oh were measured or calculated by the methods described below. The results of the measurement and calculation are shown in Table 3 below.

<Measurement of Dynamic Surface Tension σ>

For each ink, its dynamic surface tension with a surface age in the range of 10 milliseconds or more but 1000 milliseconds or less was measured by the maximum bubble pressure method on a dynamic surface tensiometer (“BP-100” manufactured by KRUSS). The dynamic surface tension was measured in an environment at a temperature of 25° C. The result was then subjected to Hua-Rosen fitting by the least-square method such that Formula (2) noted above holds, and thereby the dynamic surface tension of the ink with a surface age in the range of 0.010 milliseconds or more but less than 10 milliseconds was calculated. In this way, the dynamic surface tension (γ_{0.027}) with a surface age of 0.027 milliseconds, that is, the dynamic surface tension σ (in mN/m) was calculated.

For confirmation, a sample composition was prepared in which the surfactant in each ink was replaced with the same amount of water, and its static surface tension was measured. The static surface tension of the sample composition was approximately equal to the dynamic surface tension (γ_{0.01}) of the corresponding ink with a surface age of 0.01 milliseconds. Also the static surface tension of each ink was measured. The static surface tension of each ink was approximately equal to the dynamic surface tension (γ_{eq}) with a surface age of 1000 milliseconds of that ink.

<Measurement of Viscosity>

The viscosity (in mPa·s) of each ink was measured on a falling-ball viscometer (“Lovis 2000” manufactured by Anton Paar). The viscosity was measured in an environment at a temperature of 32° C.

<Measurement of Density ρ>

The mass (in g) of 1 L (one litter, i.e., 1000 cm³) of each ink was measured, and from it the density ρ (in g/cm³) of the ink was calculated. The density ρ was measured in an environment at a temperature of 32° C.

<Measurement of Droplet Diameter L>

The droplet diameter L was measured in an environment at a temperature of 32° C. First, the mass Wpa (in g) of a PET film before continuous ejection was measured. Subsequently, from each of N nozzles in a recording head, 10000 ink droplets were ejected continuously onto the PET film. Subsequently, the mass Wpb (in g) of the PET film after continuous ejection was measured. From the Wpa and Wpb so measured, the total mass Wic of the ejected ink was calculated according to Formula (3) below. From the Wic so calculated and the number of nozzles N previously known, the mass Wid of the ink per one droplet was calculated. Assuming that the ink droplet was spherical, from the Wid so calculated and the density ρ of the ink measured previously, the droplet diameter L of the ink was calculated according to Formula (5) below.

Wic=Wpb−Wpa (3)

Wid=Wic/(N×10000) (4)

V=Wid/ρ=4/3−πr³=4/3−π[(L×10⁻⁴)/2]³ (5)

The symbols used in Formulae (3) to (5) are as follows:
Wic: the total mass of the ejected ink (in g)
Wpb: the mass of the PET film after continuous ejection (in g)
Wpa: the mass of the PET film before continuous ejection (in g)
Wid: the mass of the ink per droplet (in g)
N: the number of nozzles in the recording head
V: the volume of the ink droplet (in cm³)
ρ: the density of the ink (in g/cm³)
r: the radius of the ink droplet (in cm)
L: the iameter of the ink droplet (in μm)

<Calculation of Ohnesorge Number Oh>

From the dynamic surface tension σ, the viscosity μ, the density ρ, and the droplet diameter L calculated, the Ohnesorge number Oh was calculated according to Formula (1) noted earlier.

[Evaluation]

With inks (CI-1) to (CI-6), the line width and the ejection displacement observed when an image was formed on a poorly absorbent recording medium were evaluated. Unless otherwise stated, the evaluation was conducted in an environment at a temperature of 25° C. and a humidity of 60% RH. The results of evaluation are shown in Table 3 below.

TABLE 3

| | | | | | | | Evaluation | |
|---|---|---|---|---|---|---|---|---|
| | | | | | | | | Ejection |
| | | σ | μ | ρ | | | Line | Displace- |
| | | (mN/ | (mPa · | (g/ | L | | width | ment |
| | Ink | m) | s) | cm³) | (μm) | Oh | (μm) | (μm) |
| C. | CI-1 | 58.15 | 5.58 | 1.04 | 16.10 | 0.179 | 46.98 | 10.44 |
| Ex. 1 | | | | | | | | |
| P. | CI-2 | 53.02 | 5.60 | 1.04 | 16.20 | 0.188 | 44.95 | 10.60 |
| Ex. 1 | | | | | | | | |
| C. | CI-3 | 52.88 | 5.67 | 1.04 | 16.22 | 0.189 | 45.80 | 12.25 |
| Ex. 2 | | | | | | | | |
| P. | CI-4 | 57.07 | 5.75 | 1.04 | 16.26 | 0.185 | 45.41 | 10.98 |
| Ex. 2 | | | | | | | | |
| P. | CI-5 | 57.24 | 5.72 | 1.04 | 16.16 | 0.184 | 44.71 | 10.53 |
| Ex. 3 | | | | | | | | |
| P. | CI-6 | 55.30 | 5.60 | 1.04 | 16.25 | 0.183 | 45.60 | 10.47 |
| Ex. 4 | | | | | | | | |

<Evaluation Apparatus Etc.>

As an inkjet recording apparatus for evaluation, an inkjet recording apparatus provided with a line head (a test-product evaluation apparatus manufactured by Kyocera Document Solutions Inc.) was prepared. The line head had nozzles with a diameter of 20 μm. The amount of ink ejected from the line head per pixel was set to 2 μL. The speed of the ink ejected from the line head was set to 8.0 m/s. The line head was loaded with one of inks (CI-1) to (CI-6) as evaluation targets. The poorly absorbent recording medium used for evaluation was coated paper (“OK TopKote Plus,” manufactured by Oji Paper Co., Ltd.). The conveyance speed of the coated paper was set to 20 m/min.

<Formation of an Evaluation Image>

On the evaluation apparatus, an evaluation image having two fine parallel lines was formed on coated paper. The fine lines formed each had the width of one pixel. That is, the fine lines formed were each a one-dot line. The interval (line-to-line pitch) between the adjacent fine lines was set to seven pixels. After image formation, the coated paper was fully air-dried. The image formed on the coated paper was then read on a microscope.

<Line Width>

The width of the fine lines in the evaluation image formed on the coated paper was measured at 10 places, and the average value was taken as the evaluation value. The line width was evaluated according to the following criteria.

(Criteria of Evaluation)
Good: an evaluation value of 46.00 μm or less.
Poor: an evaluation value over 46.00 μm.

<Suppression of Displaced Ejection>

In the evaluation image formed on the coated paper, the interval A between the two fine lines was measured at 204 places. The standard deviation of variations of the so measured interval A was then calculated. The value three times the standard deviation was taken as the evaluation value. Suppression of displaced ejection was evaluated according to the criteria noted below. A lower evaluation value indicates smaller variations in the interval A, meaning a smaller displacement of the landing position of ink droplets and hence a smaller ejection displacement.

(Criteria of Suppression of Displaced Ejection)
Good: an evaluation value under 11.00 μm.
Poor: an evaluation value of 11.00 μm or more.

As Table 3 shows, ink (CI-1) had an Ohnesorge number Oh under 0.180. The line width with ink (CI-1) was evaluated as poor.

As Table 3 shows, ink (CI-3) had an Ohnesorge number Oh over 0.188. The ejection displacement with ink (CI-1) was evaluated as poor.

By contrast, as shown in Tables 2 and 3, inks (CI-2), (CI-4), (CI-5), and (CI-6) each contained a pigment, a water-soluble organic solvent, water, and a surfactant. The water-soluble organic solvent contained both a glycol ether and a glycol compound. The inks had Ohnesorge numbers of 0.180 or more but 0.188 or less. With all of inks (CI-2), (CI-4), (CI-5), and (CI-6), the line width and the ejection displacement were both evaluated as good. Thus, with inks (CI-2), (CI-4), (CI-5), and (CI-6), it was possible to form an image with the desired line width and with a suppressed ejection displacement.

Based on what has been discussed above, it can be concluded that, with ink and an inkjet recording apparatus according to the present disclosure, it is possible to suppress displaced ejection from a recording head and to form an image with the desired line width on a poorly absorbent recording medium.

Ink and inkjet recording apparatuses according to the present disclosure can be used to form images on a recording medium.

What is claimed is:

1. Inkjet ink, comprising a pigment, a water-soluble organic solvent, water, and a surfactant, wherein
the water-soluble organic solvent contains both a glycol ether and a glycol compound, and
the inkjet ink has an Ohnesorge number Oh of 0.180 or more but 0.188 or less as expressed by Formula (1) below
$$Oh = \frac{μ}{\sqrt{ρσ L}} \qquad ( 1 )$$
where
μ represents a viscosity of the inkjet ink;
ρ represents a density of the inkjet ink;
σ represents a dynamic surface tension of the inkjet ink with a surface age of 0.027 milliseconds, and
L represents an ink droplet diameter of the inkjet ink.

2. The inkjet ink according to claim 1, wherein
the dynamic surface tension σ is 53.0 mN/m or more but 58.0 mN/m or less.

3. The inkjet ink according to claim 1, wherein
the viscosity μ is 5.60 mPa·s or more but 5.80 mPa·s.

4. The inkjet ink according to claim 1, wherein
the surfactant is an ethylene oxide adduct of acetylene glycol, and
a content of the surfactant in the inkjet ink is 0.3% by mass or more but 0.8% by mass or less.

5. The inkjet ink according to claim 1, wherein
the surfactant is an ethylene oxide adduct of acetylenediol, and
a content of the surfactant in the inkjet ink is 0.5% by mass or more but 1.5% by mass or less.

6. The inkjet ink according to claim 1, wherein
the glycol ether contains triethylene glycol monobutyl ether, and
the glycol compound contains propylene glycol.

7. The inkjet ink according to claim 1, wherein
a ratio of a mass of the glycol ether to a mass of the glycol compound is 0.20 or more but 0.55 or less.

8. The inkjet ink according to claim 1, wherein
a content of the glycol compound in the inkjet ink is 20.0% by mass or more but less than 35.0% by mass.

9. The inkjet ink according to claim 1, wherein
the inkjet ink is used to form an image on a poorly absorbent recording medium.

10. An inkjet recording apparatus, comprising a recording head for ejecting ink onto a recording medium, wherein
the recording medium is a poorly absorbent recording medium, and
the ink is the inkjet ink according to claim 1.
